(19) United States
(12) Patent Application Publication
(10) Pub. No.: US 2025/0190604 A1
(43) Pub. Date: Jun. 12, 2025

(54) THREAT INTELLIGENCE DIALOGUE SYSTEM FOR INTERFACING WITH A PROPRIETARY THREAT INTELLIGENCE DATABASE

(71) Applicant: Palo Alto Networks, Inc., Santa Clara, CA (US)

(72) Inventors: Yu Fu, Los Gatos, CA (US); Mengying Hu, Sunnyvale, CA (US); Kosta Rashev Rashev, Danville, CA (US); Zhibin Zhang, Santa Clara, CA (US); Lin Li, San Jose, CA (US); Mingxiao Guo, San Jose, CA (US); Shengming Xu, San Jose, CA (US); Mei Wang, Saratoga, CA (US)

(21) Appl. No.: 18/535,122

(22) Filed: Dec. 11, 2023

(51) Int. Cl. G06F 21/62; G06F 16/242; G06F 40/40

(52) U.S. Cl. CPC G06F 21/6218; G06F 16/242; G06F 40/40

(57) ABSTRACT

An LLM is adapted to generate database queries that are compatible with a proprietary database of a security provider. Adapting the LLM includes evaluating performance of the LLM after initial prompt engineering/fine-tuning to ensure that generated database queries are valid (i.e., comport to the database schema and can be executed to return results). When the LLM performance is satisfactory, a dialogue system uses the LLM to generate database queries from user queries. The dialogue system determines intent of each user query, which informs whether the query is supported. Supported user queries are converted to database queries using the LLM and submitted to the database. The dialogue system leverages another language model to generate a summarized, natural language representation of the database query results and constructs a response from the summary. The dialogue system also checks for XSS and prompt injection before database queries are ultimately submitted to the database.

### BACKGROUND

The disclosure generally relates to computing arrangements based on specific computational models (e.g., CPC G06N) and to handling natural language data (e.g., CPC G06F 40/00).

Dialogue systems are sometimes referred to as chatbots, conversation agents, or digital assistants and provide a conversational user interface. Some dialogue systems use language models, such as large language models (LLMs). A language model is a probability distribution over sequences of words or tokens occurring in natural language. An LLM is “large” because the training parameters are typically in the billions. Language models can be pre-trained to perform general-purpose tasks or tailored to perform specific tasks. Tailoring of language models can be achieved through various techniques, such as prompt engineering and fine-tuning. For instance, a pre-trained language model can be fine-tuned on a training dataset of examples that pair prompts and responses/predictions. Prompt-tuning and prompt engineering of language models have also been introduced as lightweight alternatives to fine-tuning. Prompt engineering can be leveraged when a smaller dataset is available for tailoring a language model to a particular task (e.g., via few-shot prompting) or when limited computing resources are available. In prompt engineering, additional context may be fed to the language model in prompts that guide the language model as to the desired outputs for the task without retraining the entire language model.

### BRIEF DESCRIPTION OF THE DRAWINGS

Embodiments of the disclosure may be better understood by referencing the accompanying drawings.

FIG. 1 is a conceptual diagram of a threat intelligence dialogue system that provides a secure interface for users to access information maintained in a proprietary threat intelligence database of a security provider.

FIG. 2 is a conceptual diagram of evaluating performance of an LLM that has been adapted to generate threat intelligence database queries from user queries.

FIGS. 3A-3B are a flowchart of example operations for evaluating performance of an LLM adapted to generate database queries from user queries based on validation of generated database queries.

FIG. 4 is a flowchart of example operations for processing and responding to utterances submitted to a threat intelligence dialogue system.

FIG. 5 is a flowchart of example operations for detecting and preventing cross-site scripting (XSS) attacks attempted via inputs to a threat intelligence dialogue system.

FIG. 6 is a flowchart of example operations for detecting and preventing prompt injection for attempting malicious access of a security provider's database.

FIG. 7 depicts an example computer system with a threat intelligence dialogue system and a model adapter.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Public-facing language models, such as LLMs accessible via the Internet, can answer security questions based on information that is publicly available. Disclosed herein is a language model-based dialogue system that interfaces with proprietary security databases to also leverage the wealth of security and threat intelligence information gathered by a cybersecurity provider or security provider that is not publicly available for consumption by conventional language models. The dialogue system leverages an LLM that has been adapted to generate database queries that are compatible with the proprietary database(s) of the cybersecurity or security provider. The dialogue system, which can be presented as a chatbot, processes and responds to user queries with natural language responses. To process a user query, the dialogue system first determines intent of the user query, which informs whether the system supports the query and should continue with querying the database. User queries supported by the system include those that are threat-related and are able to be answered from information stored in the database. User queries that the system determines are supported (i.e., related to threat intelligence) are converted to database queries (e.g., Structured Query Language (SQL) queries) for submission to the database by leveraging the LLM that has been adapted to convert user queries to database queries as a result of prompt engineering or fine-tuning. The dialogue system leverages another language model to generate a summarized, natural language representation of the results of executing the database query to present as a response to the natural language query. To prevent malicious accesses to the database, the dialogue system also implements secure measures itself by checking for XSS attacks and prompt injection before database queries are ultimately submitted to the database.

Adapting the LLM to generate database queries that are compatible with the proprietary database includes evaluating performance of the LLM after initial prompt engineering or fine-tuning to ensure that generated database queries are valid and can be executed to return results. For each query in a dataset representing example user queries, a model adapter uses the LLM to generate a database query for each example user query. The model adapter determines if the database query is valid based on whether the database query comports to the schema of the database and is able to be executed. Database queries that do not comport to the schema or that cannot execute are assigned a score indicating that the database queries are invalid, while those that execute and comport to the schema are scored as valid. For invalid queries that include minor errors that can be fixed with minimal effort, an automated fix is applied to the query, and the fixed query is again evaluated and assigned a respective score. The model adapter determines if the LLM performance is sufficient for deployment or if the LLM should be tuned further based on the resulting scores assigned to the database queries generated from the dataset. If the LLM performance is not sufficient for deployment, additional tuning can be performed using the fixed versions of database queries that were determined to be valid.

### Example Illustrations

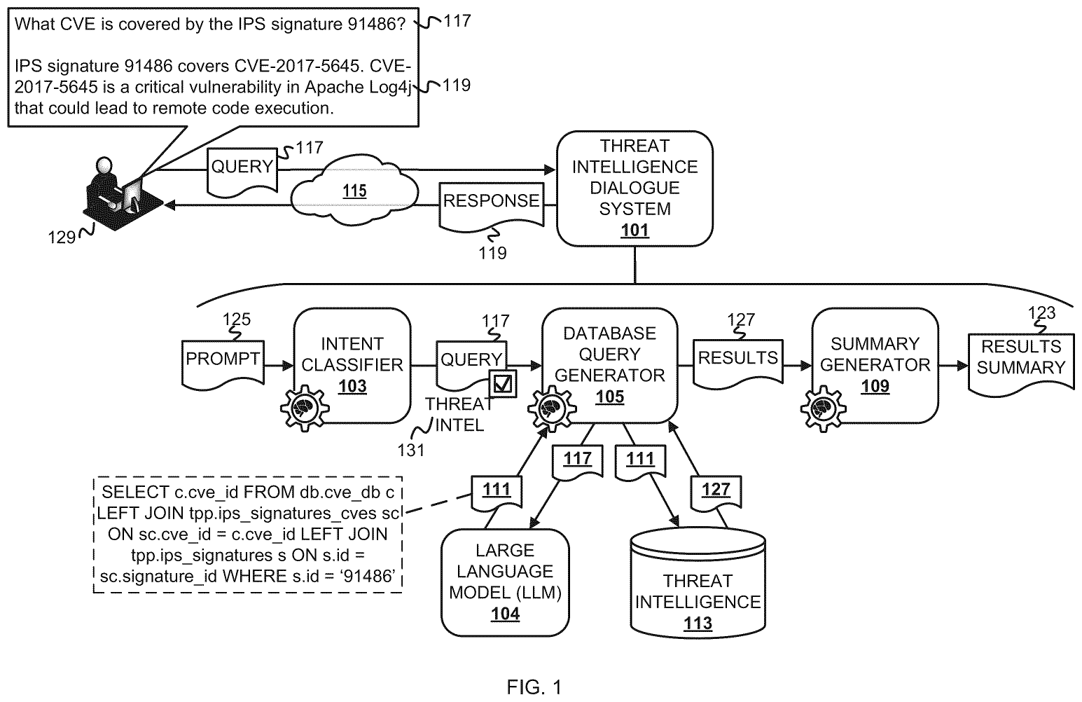

FIG. 1 is a conceptual diagram of a threat intelligence dialogue system that provides a secure interface for users to access information maintained in a proprietary threat intelligence database of a security provider. A threat intelligence dialogue system (“dialogue system”) 101 interfaces with users to answer questions related to threat intelligence by leveraging information maintained in a threat intelligence database (“database”) 113 of a security provider (e.g., a cybersecurity provider). The database 113 maintains information about threat intelligence that the security provider has gathered. The security provider can gather threat intelligence information by periodically crawling public repositories or other data sources, such as the National Vulnerability Database. Data obtained from public repositories or other data sources can then be enriched and/or sanitized before storage in the database 113, such as to add titles of vendor products associated with identified vulnerabilities. Examples of information that the security provider has gathered and stored in the database 113 include enriched Common Vulnerabilities and Exposures (CVE) data/metadata (e.g., vulnerabilities identified in vendor products and the affected products, publication dates, vulnerable software and versions, links to proofs of concept, etc.) and threat prevention information of products of the security provider (e.g., intrusion prevention system (IPS) signature data/metadata, product release/update dates, etc.). The database 113 is proprietary and thus cannot be directly accessed by end users (e.g., customers of the security provider). The dialogue system 101 generates database queries for submission to the database 113 from valid user queries. A user query is valid if it relates to threat intelligence and can be answered based on information maintained in the database 113 and also if it does not include malicious text indicative of an attempted injection attack (e.g., via XSS and/or prompt injection).

The dialogue system 101 comprises a plurality of models that includes an intent classifier 103, a database query generator 105, and a summary generator 109, each of which leverages a respective language model. Each of the intent classifier 103, database query generator 105, and/or the summary generator 109 can comprise an interface for a language model that has been adapted to perform a specific task as a result of prompt engineering and/or fine-tuning (e.g., a fine-tuned LLM). The intent classifier 103, database query generator 105, and summary generator 109 are described in further detail below.

In this example, a user 129 has initiated a conversation (i.e., a session) with the dialogue system 101. Queries of the user 129 are submitted to the dialogue system 101 via a network 115 (e.g., a public network or the Internet) since this example assumes that the dialogue system 101 is deployed as a remote service. The user 129 submits a first user query 117 that has the text, “What CVE is covered by the IPS signature 91486?” The user query 117 traverses the network 115 and is received by the dialogue system 101. The dialogue system 101 generates a prompt 125 to provide to the intent classifier 103 for classification of intent of the user query 117. The prompt 125 may be the user query 117 or may be a modified version of the user query 117 (e.g., based on preprocessing of the user query). The dialogue system 101 provides the prompt 125 to the intent classifier 103.

The intent classifier 103 may use an LLM (e.g., a transformer based LLM) or another text generation tool (e.g., a smaller language model) tuned for intent classification. The LLM or text generation tool with which the intent classifier 103 interfaces was adapted (e.g., as a result of training, prompt engineering, fine-tuning, etc.) to predict an intent classification that indicates if input text relates to threat intelligence. The intent classifier 103 can interface with a publicly available (e.g., open source) and/or pretrained model and adapt the publicly available model for the task of intent classification, such as via an application programming interface (API) of the model. Adapting the model with which the intent classifier 103 interfaces for this task used a training dataset of example prompts and intents, such as user queries labeled with intents that indicate whether the user query relates to threat intelligence. Intent classes determined by the intent classifier 103 through use of the model may be Booleans or binary values that correspond to whether a user query relates to threat intelligence. Accordingly, the intent classifier 103 receives the prompt 125 and classifies the user query 117 into an intent class 131 based on running the model on the prompt 125. This example assumes that the user query 117 was classified into the intent class 131, indicating that the user query 117 is related to threat intelligence.

The intent classifier 103 determines if determined intent classes of user queries are supported. An intent is supported by the dialogue system 101 if it relates to threat intelligence. Because the database 113 is proprietary, the dialogue system 101 limits querying of the database 113 to user queries with supported intents to prevent unauthorized or malicious access of the database 113. In this example, the intent classifier 103 determines that the user query 117 is supported because the intent class 131 indicates that it relates to threat intelligence. The user query 117 can thus be passed to the database query generator 105 for generation of a database query from the user query 117 for submission to the database 113.

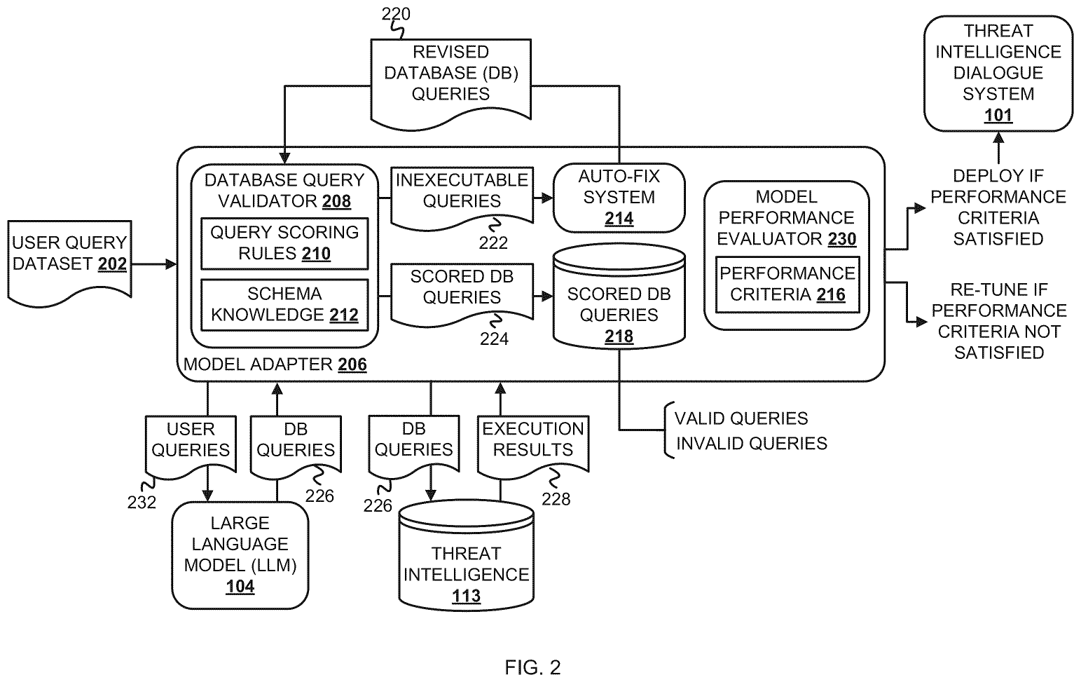

The database query generator 105 interfaces with an LLM 104 (e.g., a via an API of the LLM 104) that has been adapted to generate database queries from user queries. In this example, the LLM 104 has been adapted to generate SQL queries from user queries. Similar to the intent classifier 103, the LLM 104 may have been a publicly available and/or pretrained LLM that was adapted to perform the task of generating database queries compatible with the database 113 from user queries. Adapting the LLM 104 for this task used a training dataset of example user queries and corresponding database queries, and performance of the LLM 104 once adapted was evaluated to ensure that the LLM 104 generates valid, executable database queries as is described below in reference to FIG. 2.

The database query generator 105 prompts the LLM 104 to generate a database query from the user query 117. A prompt that the database query generator 105 constructs for submission to the LLM 104 may include the user query 117 and additional contextual information, such as information about a schema of the database 113. The LLM 104 generates a database query 111 from the user query 117. The database query 111 depicted in FIG. 1 that comprises the SQL query “SELECT c.cve_id FROM db.cve_db c LEFT JOIN tpp.ips_signatures_cves sc ON sc.cve_id=c.cve_id LEFT JOIN tpp.ips_signatures s ON s.id=sc.signature_id WHERE s.id=‘91486’”. This SQL query retrieves from the database 113 an identifier of a CVE that is covered by the IPS signature 91486 as requested in the user query 117. The database query generator 105 (or a database interface of the dialogue system 101 that obtains database queries from outputs of the database query generator 105) queries the database 113 with the database query 111 and obtains results 127.

The summary generator 109 generates a summary 123 of the results 127 from which a response to the user query 117 is to be constructed. The summary generator 109 can leverage another language model that is adapted to summarize results of querying the database 113 to generate the summary 123. This language model may be an LLM or may be smaller than an LLM (e.g., in terms of model parameters). The summary generator 109 can construct prompts that are submitted to the language model based on prior prompt engineering conducted for the language model (e.g., via few-shot prompting). Prompts generated by the summary generator 109 at least include the results obtained from querying the database 113 and an instruction to generate a summary of the results. Since results returned from the database 113 generally will not be in natural language, the summary generator 109 may append additional context to generated prompts, such as information about a schema of the database 113, database 113 field descriptions, and other information obtained from the security provider that offers the database 113 to enhance natural language summaries of the results.

The dialogue system 101 constructs a response 119 to the user query 117 from the summary 123. The response 119 at least includes the summary 123, though implementations may also include the results 127 themselves. The response 119 traverses the network 115 and is received by the user 129. In this example, the response 119 states, “IPS signature 91486 covers CVE-2017-5645. CVE-2017-5645 is a critical vulnerability in Apache Log4j that could lead to remote code execution.” The user 129 may choose to ask additional questions about this IPS signature, CVE, or other information reflected in the response 119, as the dialogue system 101 can maintain conversational memory to inform subsequent user queries submitted by the user 129.

While depicted as one database in FIG. 1 for simplicity, the database 113 can encompass multiple databases in which the security provider stores threat intelligence information that it has collected. For instance, a first database can maintain threat intelligence information gathered from publicly accessible data sources (e.g., repositories) obtained by crawlers deployed by the security provider, and a second database can maintain proprietary threat intelligence information of the security provider. For these cases, the intent classifier 103 may classify intents of user queries as corresponding to one of the information sources so that a database query for the respective database can be generated. To illustrate, the intent classifier 103 can classify general questions about CVEs or vulnerabilities identified in external vendors' products with an intent that can be served by the first database and can classify specific questions about the security provider's offerings, such as CVE coverage and IPS signatures, with an intent that can be served by the second database. Intent classes that the intent classifier 103 determines can thus inform the database query generator 105 of the database that should be queried. The database query generator 105 can thus append an indication of the database to be queried to prompts submitted to the LLM 104 based on the intent class determined for each user query and submits the generated database query to the corresponding database. In other words, the database query generator 105 can route generated database queries to an appropriate database based on the intent of the corresponding user query determined by the intent classifier 103.

FIG. 2 is a conceptual diagram of evaluating performance of an LLM that has been adapted to generate threat intelligence database queries from user queries. This example depicts a model adapter 206 that evaluates performance of the LLM 104 after its initial adaptation for generating database queries compatible with the database 113 from user queries. Adaptation of the LLM 104 can be based on fine-tuning the LLM 104 to generate database queries from user queries or engineering prompts that are provided to the LLM 104 as input for the task of generating a corresponding database query. The model adapter 206 obtains a user query dataset (“dataset”) 202 that comprises example user queries that could be submitted to the dialogue system 101. The dataset 202 may be a subset of a training dataset that was split into train/test subsets such that the dataset 202 includes pairs of user queries and corresponding database queries. In other examples, such as if a smaller set of training data comprising user query and database query pairs is available, the dataset 202 may be independent of the dataset used for adaptation of the LLM 104.

The model adapter 206 prompts the LLM 104 with each of the user queries in the dataset 202, depicted in FIG. 2 as user queries 232, to generate corresponding database queries 226. The model adapter 206 then submits each of the database queries 226 to the database 113 to obtain execution results 228. Each of the execution results 228 corresponding to one of the database queries 226 may indicate results comprising data of the database 113 that satisfy the database query if the database query was able to execute against the database 113. Alternatively, an execution result may indicate an error message and/or error code if the corresponding database query was not able to execute. A database query validator (“query validator”) 208 of the model adapter 206 evaluates the database queries 226 and the execution results 228 to determine whether the LLM 104 is generating valid database queries that can execute against the database 113 for retrieval of data that it maintains or if the LLM 104 is generating an unacceptable amount of database queries with errors that prevent their execution. The query validator 208 evaluates each of the database queries 226 and corresponding one of the execution results 228 based on query scoring rules (“rules”) 210 and schema knowledge 212. The schema knowledge 212 with which the query validator 208 has been configured comprise information about the schema of the database 113 (e.g., the defined tables, fields, etc.) based on which the query validator 208 evaluates each of the database queries 226 to determine if the database queries 226 are consistent with the schema of the database 113. Inexecutable database queries can comprise errors that are attributable to inconsistencies with the database schema, and the model adapter 206 can identify these errors using the schema knowledge 212.

The rules 210 indicate scores that can be assigned to database queries and corresponding conditions for assigning each score to a database query. Table 1 depicts an example of the scoring rules 210 that includes both numeric scores and binary scores and corresponding conditions for assignment of each score. The query validator 208 can assign numeric and/or binary scores to database queries and can use the execution status (i.e., whether the database query can execute), assignment conditions, or a combination thereof for determining the score to assign. For instance, the query validator 208 can score database queries according to the numeric scores and assignment conditions indicated in the rules 210 by evaluating database queries based on the schema knowledge 212 to determine which of the assignment conditions are satisfied. While the example assignment conditions are depicted in Table 1 as general descriptions for ease of understanding, since different errors can produce different error messages or error codes (e.g., SQL error codes), the assignment conditions of the rules 210 can indicate error messages/codes that may be indicated in execution results. The query validator 208 can thus evaluate error messages/codes indicated in execution results returned for a database query that could not execute based on the rules 210 to determine a score to assign to the database query. The conditions for error codes can include one or more error codes, a range(s) of error codes, etc. In implementations, the query validator 208 can assign both numeric and binary scores indicated in the rules 210 to database queries, where the binary score facilitates classification of whether a database query could execute and was thus valid or invalid, and the numeric score provides a more fine-grained insight into why the database query is valid or invalid.

TABLE 1

| SCORE | SCORE | CAN BE | ASSIGNMENT |
|---|---|---|---|
| (NUMERIC) | (BINARY) | EXECUTED? | CONDITION(S) |
| 1 | 0 | NO | Invalid value(s) |
| | | | Wrong table |
| | | | queried |
| 2 | 0 | NO | Incorrect or |
| | | | unnecessary join |
| 3 | 0 | NO | Nonexistent field |
| | | | name(s) |
| 4 | 1 | YES | Timestamp issue |
| | | | Missing |
| | | | condition(s) |
| | | | Field mismatch |
| | | | with minor issues in |
| | | | results |
| 5 | 1 | YES | Field mismatch but |
| | | | results are |
| | | | acceptable |
| 6 | 1 | YES | No issues |

Some queries that the query validator 208 determines are inexecutable can be revised by an auto-fix system 214 of the model adapter 206. The auto-fix system 214 performs fix attempts for an eligible subset of the database queries 226 that are inexecutable, depicted in FIG. 2 as inexecutable queries 222, in an attempt to bring the inexecutable queries 222 in conformity with the database 113 schema and thus able to be executed. The inexecutable queries 222 may comprise a subset of the database queries scored as inexecutable by the query validator 208 but for which a simple fix may be possible. For instance, for implementations where numeric scores are assigned, the query validator 208 can provide select ones of the inexecutable queries to the auto-fix system 214 for which a simple fix is likely to render these queries executable. The criterion for database queries that are provided to the auto-fix system 214 can be based on the score assigned by the database query validator 208. To illustrate, in the example where the rules 210 indicate scores of 1 to 6, the query validator 208 can provide database queries with scores of 3 to the auto-fix system 214. As reflected in the example of the rules 210 above, database queries assigned a score of 3 may simply include a field name that is not actually present in the database 113. The inexecutable queries 222 can thus comprise those of the database queries 226 satisfying the score criterion (e.g., those with a score of 3). For these examples, the auto-fix system 214 can identify the nonexistent field names based on the schema knowledge 212 or a subset thereof with which it has been configured and remove the expression(s) or other component(s) of the inexecutable queries 222 that reference the nonexistent field name to generate revised database queries 220. The auto-fix system 214 can perform other fix attempts for others of the inexecutable queries 222 based on the schema knowledge 212 (or subset thereof) to attempt to bring the inexecutable queries 222 into conformity with the database 113 schema. In implementations, the auto-fix system 214 can also revise a subset of the database queries 226 that are executable but have minor issues, such as those assigned scores of 4 according to the above criteria. For instance, the auto-fix system 214 can revise a database query determined to have a timestamp mismatch with respect to a timeframe or time window indicated in the corresponding user query by correcting the timestamp indicated in the database query, where the correction leverages the timestamp information provided in the user query.

The auto-fix system 214 provides the revised database queries 220 to the query validator 208 for validation of the revised database queries 220. The query validator 208 submits the revised database queries 220 to the database 113 and evaluates results of executing each revised database query to determine if the revision rendered the claim valid and executable or if the database query still does not execute, with the query validator 208 scoring the revised database queries 220 based on the rules 210 accordingly. For those of the revised database queries 220 that still do not execute, the query validator 208 can discard the queries since fix attempts may be capped at one per inexecutable query, though the query validator 208 may pass these queries to the auto-fix system 214 for an additional fix attempt. Inexecutable ones of the revised database queries 220 can be discarded because they are not informative of the performance of the LLM 104 itself, and the model adapter 206 instead retains the original, corresponding one of the database queries 226 and its score for the purposes of LLM 104 performance evaluation.

As the query validator 208 scores the database queries 226, resulting in scored database queries 224, the query validator 208 inserts the scored database queries 224 into a database 218 or other data structure. The scored database queries 224 comprise each of the database queries 226 and the corresponding scores assigned by the query validator 208. The query validator 208 may also store a valid subset of the revised database queries 220 and their corresponding scores in the database 218 in association with their original, unfixed counterparts that the LLM 104 generated or may store the valid subset of the revised database queries 220 and their scores in another database to have these revised database queries available for subsequent reference. The valid subset of the revised database queries 220 can include those that were executable and/or those having a score that satisfies a threshold, such as those with a score of 5 or greater when using the example of the rules 210 provided above. Those of the revised database queries 220 that are stored for subsequent reference should be maintained separately from the scored database queries 224 since the LLM 104 did not actually generate these queries, so they are not an accurate representation of performance of the LLM 104 itself. The query validator 208 may store the corresponding ones of the user queries 232 with the valid subset of the revised database queries 220 to provide additional training data for further tuning of the LLM 104.

A model performance evaluator (“performance evaluator”) 230 evaluates performance of the LLM 104 based on the quality of database queries that it has generated as reflected by the scores assigned by the query validator 208. The performance evaluator 230 has been configured with performance criteria 216 based on which it evaluates the scores maintained in the database 218. The performance criteria 216 can comprise a criterion/criteria for counts of scores that exceed and/or are below a threshold, a criterion/criteria for an aggregate (e.g., average or sum) of the scores, and/or a criterion for another statistical analysis performed for the scores. As an example, the performance criteria 216 can indicate a threshold corresponding to an average score against which the performance evaluator 230 evaluates an average of the scores maintained in the database 218. In this case, the performance criteria 216 are satisfied if the average score satisfies (i.e., exceeds or meets) the threshold.

The model adapter 206 can take various actions depending on the results of the performance evaluation by the performance evaluator 230. If the performance criteria 216 are satisfied, the model adapter 206 indicates that the LLM 104 is ready for deployment to interface with the dialogue system 101. The model adapter 206 may generate a notification that it communicates to the security provider indicating that the LLM 104 is performing sufficiently well to be deployed for generation of database queries from actual user queries. If the performance criteria 216 are not satisfied, the model adapter 206 can re-tune the LLM 104 to improve its reliability in generating valid, executable database queries from user queries. For re-tuning the LLM 104, the model adapter 206 may add those of the revised database queries 220 that were executable and/or scored above a threshold (e.g., a 5 or greater with a scoring system of 1 to 6) that were stored along with the corresponding user queries to the dataset used for tuning the LLM 104.

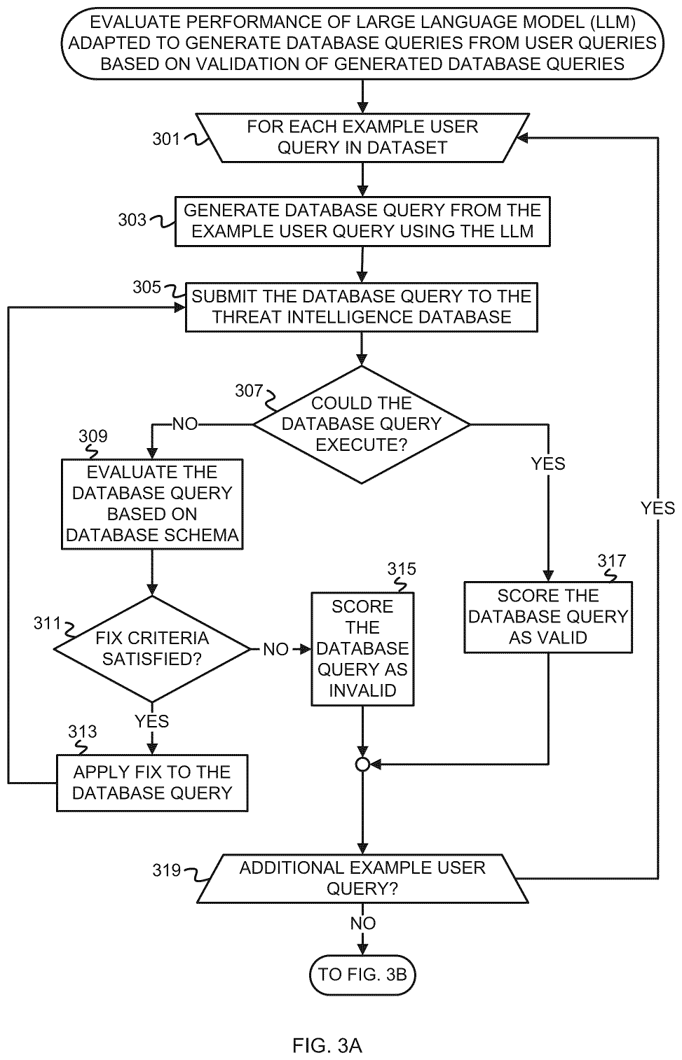

FIGS. 3-5 are flowcharts of example operations. The example operations are described with reference to a threat intelligence dialogue system (herein after “the dialogue system”) and a model adapter for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIGS. 3A-3B are a flowchart of example operations for evaluating performance of an LLM adapted to generate database queries from user queries based on validation of generated database queries. A model adapter has already adapted the LLM for this task with an initial dataset, such as a training dataset that comprises pairs of example user queries and corresponding database queries (e.g., database queries) for fine-tuning a pretrained LLM. The example operations are performed to determine if performance of the LLM is satisfactory for deployment to interface with the dialogue system and process actual user queries. The example operations are described with reference to a threat intelligence database of a security provider but can also be expanded to an additional database(s) of the security provider with which the dialogue system interfaces.

At block 301, the model adapter begins iterating over each example user query in a dataset. The dataset comprises a set of example user queries that are supported by the dialogue system (i.e., relate to threat intelligence/can be converted to a database query for a threat intelligence database of the security provider). At least a subset of the example user queries in the dataset should be different from those used for initial adaptation of the LLM.

At block 303, the model adapter generates a database query from the example user query using the LLM. The model adapter generates a prompt at least comprising the example user query and inputs the prompt into the LLM to retrieve a corresponding database query as the LLM output. The prompt can also include context that the model adapter has been configured to include in generated prompts.

At block 305, the model adapter submits the database query to the threat intelligence database. The model adapter can submit the database query to the threat intelligence database via a database interface (e.g., an API of the threat intelligence database). The threat intelligence database maintains proprietary metadata/data obtained by the security provider, such as enriched CVE data/metadata and threat intelligence information provided by proprietary systems of the security provider. Enriched CVE data/metadata can include links to proofs of concept, vendors and/or products affected by a CVE, vulnerable software and/or version number(s), and first publication date. Threat intelligence information can include information about IPS signature coverage, release/update dates of the IPS signatures, and other information about the security provider's product offerings.

At block 307, the model adapter determines if the database query could execute. The database query can execute if submitting it to the database resulted in valid results being returned. Results are valid if they comprise data maintained in the database that satisfy the database query or if they indicate that no results satisfy the database query. Results are invalid if they comprise an error message and/or error code indicating that the database query could not be executed against the database to search for matching results. If the database query could not be executed, operations continue at block 309. If the database query could be executed, operations continue at block 317.

At block 309, the model adapter evaluates the database query based on a schema of the database. The model adapter has been configured with information about the database schema based on which it evaluates generated database queries to determine whether the database queries comport to the schema. The model adapter evaluates the database query based on the schema to determine if the database query is consistent with the database schema. A database query is consistent with the database schema if it includes references to existing tables, existing fields, valid (i.e., defined) values of each field, etc. A database query is inconsistent with the database schema if it includes nonexistent fields, references to the wrong tables, etc.

At block 311, the model adapter determines if fix criteria are satisfied. The model adapter maintains one or more criteria that, if satisfied, result in the model adapter attempting to fix the database query. The fix criteria may be satisfiable by database queries that include minor errors with respect to the database schema. The model adapter has been configured with rules for what constitutes a minor error, such as a nonexistent field name. The model adapter may also enforce a maximum count of minor errors that can be present for an automated fix to be possible (e.g., one or two minor errors per database query). Database queries with more complex errors that may not satisfy the fix criteria can include undefined/imaginary values of fields of the database, incorrect or unnecessary joins, or querying of the wrong table. Additionally, the model adapter may enforce a maximum number of fix attempts for database queries that cannot be executed. As an example, the model adapter may attempt a maximum of one fix per inexecutable database query that satisfied the fix criteria. The fix criteria thus are not satisfied if the model adapter has already met this limit on attempted fixes for the database query and it still cannot be executed. If the fix criteria are satisfied, operations continue at block 313. If the fix criteria are not satisfied, operations continue at block 315.

At block 313, the model adapter applies a fix to the database query. The model adapter determines and applies a fix to attempt to correct the error(s) that resulted in an inability to execute the database query. The model adapter utilizes information about the database schema to determine the error(s) in the database query. Generally, the model adapter fixes database queries to attempt to bring the database query closer to adherence with the database schema. For instance, if the database query indicates a nonexistent field, the model adapter can remove the clause, expression, etc. that comprises the nonexistent field. Operations continue at block 305 where the model adapter submits the database query with the fix applied.

At block 315, the model adapter scores the database query as invalid. The model adapter was configured with scoring rules comprising scores that indicate if a respective query is valid or invalid and the corresponding criteria for assigning the score to a database query. The scores may be binary (e.g., 0 and 1) such that the model adapter assigns the score indicating invalidity to the database query since it could not execute and could not successfully be fixed. Alternatively, the model adapter may be configured with a range of numeric scores such that the model adapter assigns a score on the lower end of the range depending on the severity of errors identified in the database query. To illustrate, the model adapter may be configured with scoring rules for scores of 1 to 6, where scores of 1, 2, and 3 are assigned to inexecutable queries to allow scores to be reflective of the issues with database queries with higher granularity. In this case, the model adapter can evaluate the database query based on the scoring rules to determine which score to assign. Criteria associated with each score in the scoring rules may indicate a corresponding error(s) in consistency with the database schema, and the model adapter assigns a score associated with the error(s), which was identified at block 309 for the database query. The error(s) reflected by each of the criterion can be represented with an error message and/or error code that may be identified in results returned from the database, where the model adapter assigns the score to the database query that corresponds to the error message and/or error code returned for the database query. The model adapter can associate the score with the database query and stores the database query and its score for later reference, such as in a database or data structure, in a file to which the model adapter writes, etc.

At block 317, the model adapter scores the database query as valid. The scores may be binary such that the model adapter assigns the score indicating validity to the database query. Alternatively, the model adapter may maintain a range of numeric scores such that the model adapter assigns a score on the higher end of the range depending on whether the database query includes any minor errors that do not affect its ability to be executed and return substantially correct results. Returning to the example where the model adapter is configured with scoring rules for scores of 1 to 6, scores of 4, 5, and 6 may be assigned to executable queries to allow scores to be reflective of the quality of the generated database queries more granularly, with a score of 6 assigned to database queries with no issues. In this case, the model adapter can evaluate the database query based on the scoring rules to determine which score to assign. Each score in the scoring rules may indicate a corresponding minor issue(s), and the model adapter assigns a score associated with the minor issue(s) identified for the database query at block 309 (if any). Scoring rules for executable database queries may also consider the results returned from executing the database query. The model adapter can associate the score with the database query and stores the database query and its score for later reference.

At block 319, the model adapter determines if there is another example user query in the dataset. If there is another example user query in the dataset, operations continue at block 301. Otherwise, operations continue at block 321 of FIG. 3B.

At block 321, the model adapter evaluates performance of the LLM based on scores of the generated database queries. Evaluation of the score of the database queries can be relative to the count of database queries. For instance, the model adapter can aggregate (e.g., add or average) the scores. The model adapter may perform additional statistical analysis of the spread of scores (e.g., standard deviation).

At block 323, the model adapter determines if performance is satisfactory for deployment of the LLM. The model adapter determines if the scores of the database queries satisfies one or more criteria indicating satisfactory performance. If the model adapter aggregated the scores, the criteria may indicate a minimum score against which the model adapter evaluates the aggregate score to determine if it is above the minimum. The minimum score may be a hardcoded value or may be computed relative to the total count of database queries. Multiple criteria can be enforced, such as criteria that the average of the scores exceeds a first threshold and a standard deviation is below a second threshold, that the total counts of valid and invalid scores exceed and are below respective thresholds, etc. If the performance of the LLM is not satisfactory, operations continue at block 325. If the performance of the LLM is satisfactory, operations continue at block 327.

At block 325, the model adapter re-tunes the LLM using a select subset of the fixed database queries. If the performance of the LLM is not yet satisfactory, the model adapter can continue tuning (e.g., fine-tuning) the LLM on pairs of user queries and generated database queries until its performance is satisfactory. The model adapter can add those of the fixed database queries that were able to be executed or those that received a sufficient score (e.g., a score above a threshold) to the dataset used for re-tuning.

At block 327, the model adapter indicates that the LLM can be deployed. The model adapter can indicate that the LLM is ready for deployment to the security provider by generating a notification, via a graphical user interface (GUI), etc. The security provider in response can then connect the LLM to the dialogue system (e.g., via import of a library that implements the LLM or an interface thereof to the dialogue system).

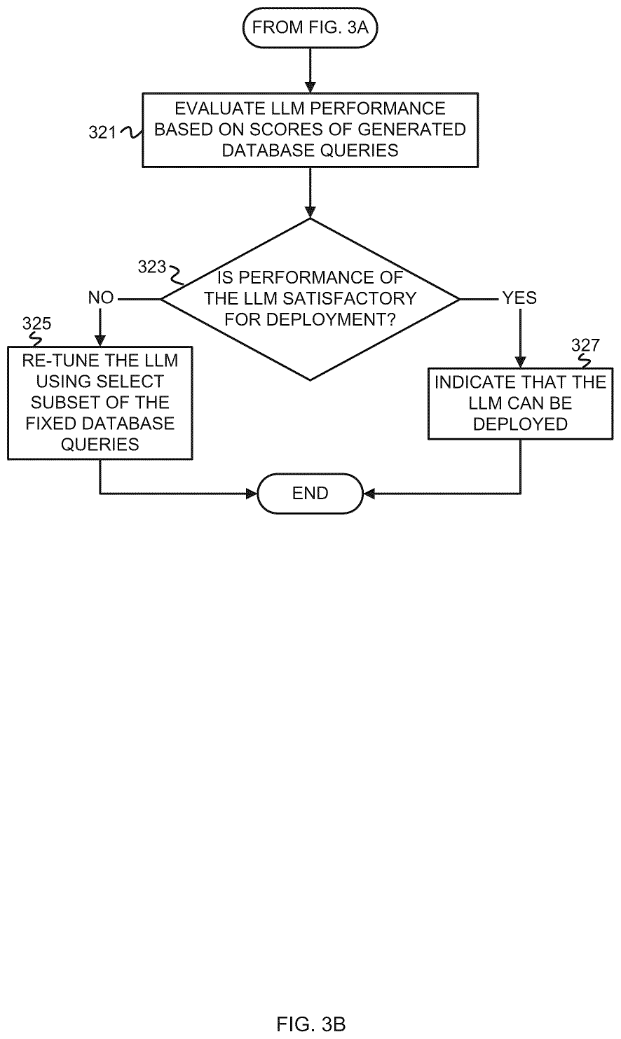

FIG. 4 is a flowchart of example operations for processing and responding to utterances submitted to a threat intelligence dialogue system. Utterances are human language inputs to the dialogue system. The example operations assume that the dialogue system interfaces with one or more databases of a security provider that maintain information related to threat intelligence.

At block 401, the dialogue system obtains an utterance submitted to the dialogue system. Utterances can be submitted by users conversing with the dialogue system. The example operations assume that this is a first utterance of a conversation or does not rely on prior utterances or responses of an ongoing conversation, but the dialogue system can leverage conversational memory as part of performing one or more of the subsequent example operations as necessitated by the content of the utterance.

At block 403, the dialogue system determines intent of the utterance. The dialogue system can prompt an intent classifier with the utterance to determine its intent. The intent classifier has been adapted to classify intents of utterances into classes that the dialogue system recognizes as supported or unsupported. Intent classes can be binary, such as intent classes indicating whether or not the utterance relates to threat intelligence and is supported by the dialogue system. Intents may also be mapped to intent classes indicating whether or not they relate to threat intelligence. As an example, the example intent, “This user wants to know if the next-generation firewall product protects against a certain CVE” can map to the intent class of “threat intelligence related.” If the dialogue system interfaces with multiple databases of a security provider, intent classes can also correspond to the different databases. For instance, if the security provider maintains a first database of enriched, sanitized threat intelligence information gathered by the security provider from public data sources and a second database of internal threat intelligence information (e.g., IPS signatures defined by the security provider, security provider product information, etc.), then intent classes can correspond to the different databases. The prompt submitted to the intent classifier includes the utterance and may further have additional context that the dialogue system appends thereto. Prompt structure, including any additional context appended to prompts generated by the dialogue system for input to the intent classifier, may have been determined as a result of prompt engineering performed for the intent classifier. In other examples, the dialogue system can perform a substring match to determine the intent of the utterance. The dialogue system can search the utterance for a plurality of substrings, each of which corresponds to a respective intent class (e.g., “CVE,” “IPS,” names of the security provider's products, names of products of other vendors, etc.). If the utterance matches multiple substrings in different intent classes, the dialogue system can classify the intent of the utterance according to the intent class with the most substring matches.

At block 405, the dialogue system determines if the intent of the utterance is supported. The intent is supported if it indicates the utterance relates to threat intelligence and can be converted to a database query that is able to execute over a database of the security provider. The dialogue system has been configured to recognize intent classes that the intent classifier can output as supported or unsupported. In other examples, the dialogue system can determine if the intent matches one of the intent classes defined for the substring matching and the intent is thus supported or can determine if the intent does not match one of the intent classes and is thus unsupported. If the intent is supported, operations continue at block 407. If the intent is not supported, operations continue at block 410.

At block 407, the dialogue system generates a database query from the utterance with a language model that has been adapted to generate database queries from utterances. The language model generates database queries in a language compatible with the database(s) from utterances, such as SQL queries. The language model used for database query generation is generally a LLM, such as a transformer based LLM. The LLM has been fine-tuned or otherwise adapted to generate database queries from utterances that are compatible with the database(s) of the security provider, such as through prompt engineering that yielded a determination of how the dialogue system is to construct prompts submitted to the LLM. Performance of the LLM has previously been evaluated and determined to be satisfactory in that the LLM generates valid database queries for legitimate access of the database(s) (e.g., as described above in reference to FIG. 3). The dialogue system can construct a prompt comprising the utterance and an instruction to generate a database query from the utterance. The dialogue system can include additional information about the database(s) in the prompt as context, such as database schema information for the database(s). For implementations where the dialogue system interfaces with multiple databases and an intent of the utterance indicates one of the databases, the instruction to generate a database query can identify the database for which the query should be generated.

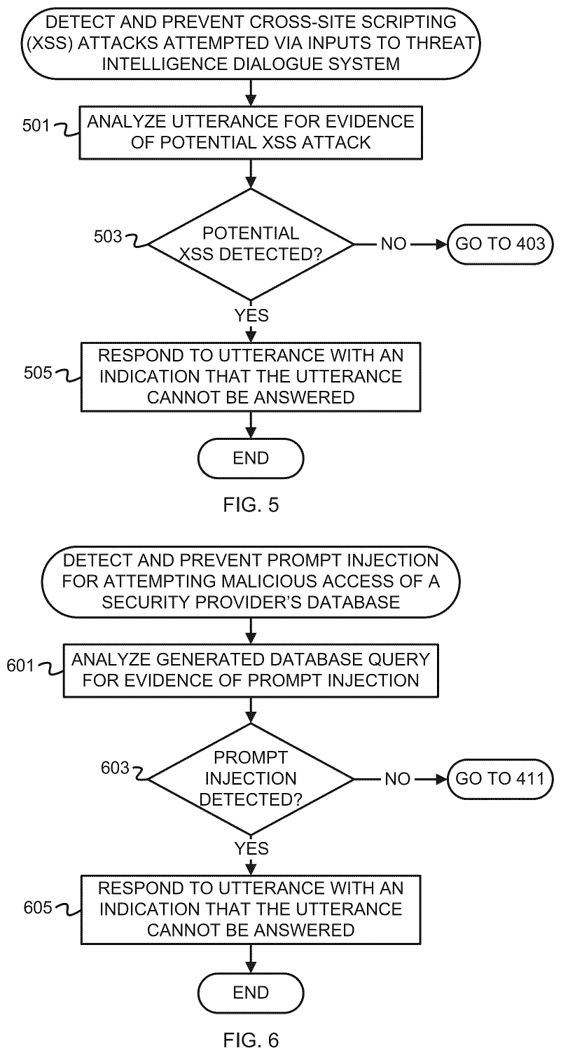

At block 409, the dialogue system determines if the generated database query is valid. Submission of the generated database query to the database may be contingent on validation of the database query, which can include one or more checks for validity. For instance, the dialogue system may validate the database query by checking for syntax errors or other minor errors in the generated database query prior to submission. If the database query includes a syntax error(s), the dialogue system can correct the syntax error before submitting the database query to the database. Examples of errors that can be corrected in generated database queries include timestamp errors (e.g., the timestamp indicated in the database query does not match a timeframe or other time window given in the utterance) and references to a wrong (e.g., nonexistent) field. Alternatively, or in addition, the dialogue system can generate a natural language summary of the database query (e.g., with a language model adapted to summarize database query language) and compare the summary to the intent of the user query using a measure of text similarity. The dialogue system can determine the database query is valid if the summary and the intent are sufficiently similar (e.g., the similarity meets a threshold). The dialogue system can determine if the generated database query is valid by checking the database query for evidence of prompt injection (as will be described further in reference to FIG. 6). The database query is determined to be invalid if includes evidence of prompt injection. If the generated database query is not valid, operations continue at block 410. If the generated database query is valid, operations continue at block 411.

At block 410, the dialogue system responds to the utterance with an indication that the utterance cannot be answered. The dialogue system may generate a default response for utterances that are unsupported (e.g., “I'm sorry, I'm afraid I can't help you with that.”). As another example, the dialogue system can generate a response requesting that the user provide more information (e.g., “I don't understand. Could you try again?”). The dialogue system can present the response for display on a GUI used by the user that submitted the utterance.

At block 411, the dialogue system submits the generated database query to the database of the security provider and obtains results. In response to submitting the database query, the dialogue system obtains results retrieved from the database that satisfy the query (if any). Obtained results may be formatted as structured data, such as JavaScript Object Notation (JSON) data.

At block 413, the dialogue system constructs a response to the utterance based on the results of the submitted database query. To construct the response, the dialogue system generates a summary of the results so that the utterance can be answered with a more easily understood, natural language representation of the data returned from the database (if any). The dialogue system generates the summary with an additional language model by prompting the language model with the results and an instruction to summarize the results. This language model may be a lightweight language model or smaller language model (i.e., relative to the LLM described above) that has been pretrained or pre-engineered for text summarization based on database query results. The dialogue system may append additional context to the prompt to guide summarization of the results and tailor the summary to the proprietary information gathered by the security provider, such as descriptions of database fields.

At block 415, the dialogue system responds to the utterance with the constructed response. The dialogue system can present the response for display on a GUI used by the user that submitted the utterance. The dialogue system also records the utterance and response to conversational memory or summaries thereof to guide responses to subsequent utterances submitted during the conversation. In the event that submitting the database query resulted in an error code, the dialogue system can respond with an indication that an error occurred.

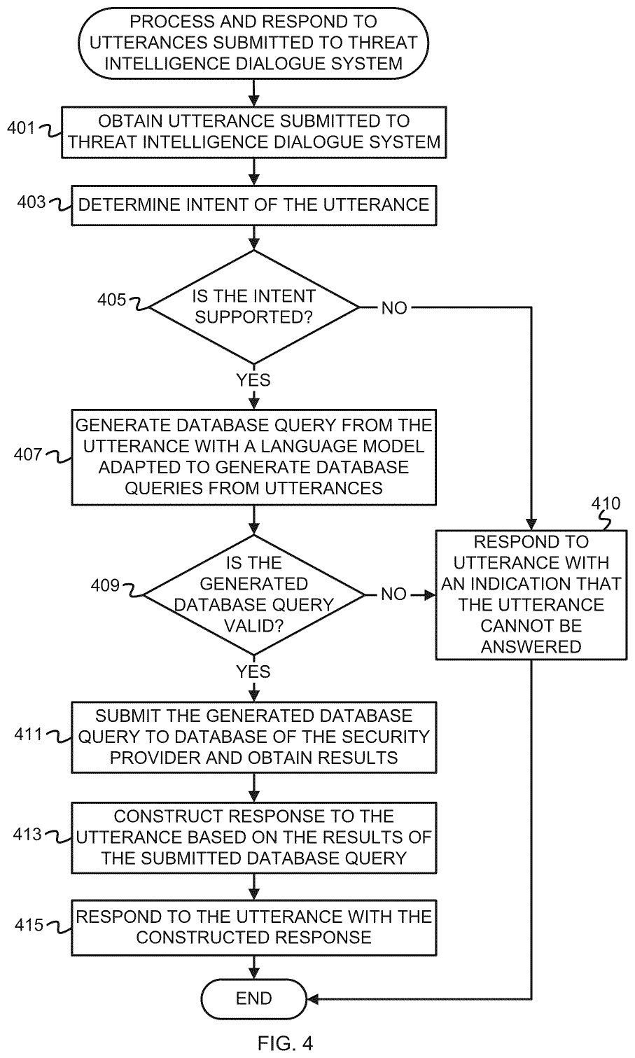

FIG. 5 is a flowchart of example operations for detecting and preventing XSS attacks attempted via inputs to a threat intelligence dialogue system. Malicious actors can attempt XSS carried out by inputting malicious scripts to the dialogue system. The example operations can be performed as part of initial processing of an utterance prior to classifying its intent (e.g., between blocks 401 and 403 of FIG. 4).

At block 501, the dialogue system analyzes an utterance for evidence of a potential XSS attempt. The dialogue system analyzes the utterance to determine if it includes a script that embeds potentially malicious executable code or data. Legitimate utterances generally will not include scripts, so the presence of scripts can be flagged as potential XSS. An utterance can be determined to include a script if the dialogue system identifies HyperText Markup Language (HTML) script tags in the utterance. For instance, the dialogue system may have been configured with one or more regular expressions that each specify a pattern for HTML script tags.

At block 503, the dialogue system determines if potential XSS is detected. The dialogue system can detect potential XSS in the utterance if it matches a regular expression or if script tags are otherwise identified in the utterance. If potential XSS is detected, operations continue at block 505. If potential XSS is not detected, operations continue at block 403 of FIG. 4, where the dialogue system proceeds with classifying intent of the utterance.

At block 505, the dialogue system responds to the utterance with an indication that the utterance cannot be answered. The dialogue system can respond with a default response that is generated when potential XSS or another potential injection attack is detected. The dialogue system does not continue with generating a database query and may terminate the conversation.

FIG. 6 is a flowchart of example operations for detecting and preventing prompt injection for attempting malicious access of a security provider's database. The example operations can be performed to evaluate a database query generated by a language model before the database query is submitted to the security provider's database, such as during validation of a generated database query as described in reference to block 409 of FIG. 4.

At block 601, the dialogue system analyzes a generated database query for evidence of prompt injection. The dialogue system can analyze the database query to ensure that it is reflective of legitimate database access, or legitimate access to the database(s) with which the dialogue system is intended to interface. Malicious actors may use prompt injection to attempt illegitimate access to the database or other resources of the security provider that evades classification as unsupported by the intent classifier. The dialogue system can analyze the database query to determine if it indicates a database to which access is allowed, to determine if it is a request to retrieve data from the database rather than to update the database or insert data into the database, and/or to otherwise determine that the database query does not include impermissible content. For instance, the dialogue system can treat any database query that is not a read operation and/or that indicates a database other than that/those with which the dialogue system is intended to interface as indicative of possible prompt injection.

At block 603, the dialogue system determines if prompt injection is detected as a result of analyzing the database query. If prompt injection is detected, operations continue at block 605. If prompt injection is not detected, operations continue at block 411 of FIG. 4, where the dialogue system proceeds with querying the threat intelligence database.

At block 605, the dialogue system responds to the utterance with an indication that the utterance cannot be answered. The dialogue system can respond with a default response that is generated when prompt injection or another potential injection attack is detected. The dialogue system does not continue with generating a database query and may terminate the conversation.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

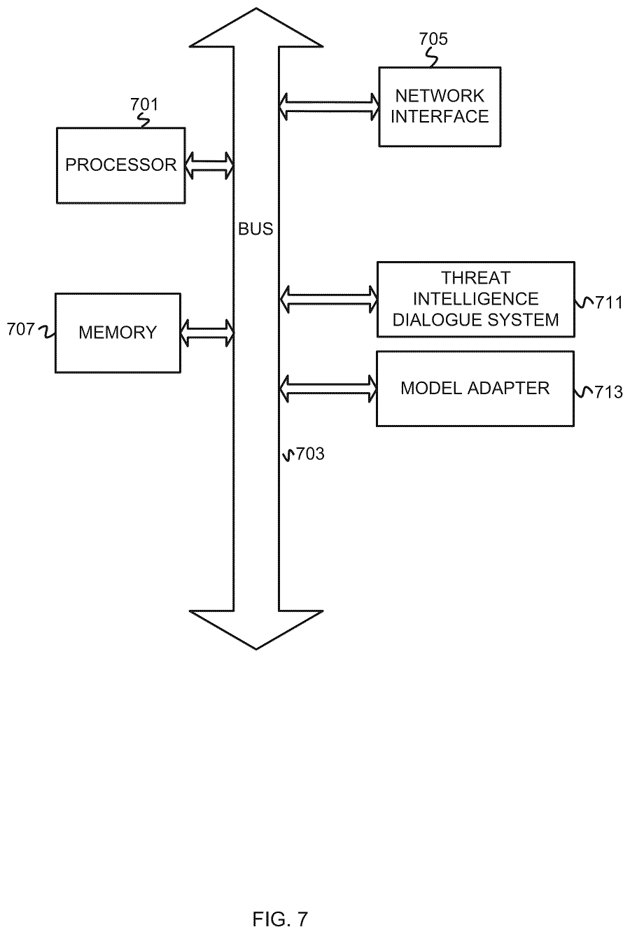

FIG. 7 depicts an example computer system with a threat intelligence dialogue system and a model adapter. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes threat intelligence dialogue system 711 and model adapter 713. The threat intelligence dialogue system 711 leverages one or more language models, including a language model that generates database queries from user queries, to provide a conversational interface between users and a database(s) of a security provider that stores proprietary threat intelligence information. The threat intelligence dialogue system 711 also checks for injection attacks to prevent malicious access of the security provider's database(s). The model adapter 713 adapts the language model for the task of generating database queries from user queries and evaluates performance of the language model before its deployment to interface with the threat intelligence dialogue system 711. While depicted as part of the same computer system in FIG. 7, the threat intelligence dialogue system 711 and the model adapter 713 do not necessarily execute as part of the same system. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
adapting a first language model to generate database queries from utterances, wherein the database queries are to be executed against a database offered by a cybersecurity provider, wherein the database maintains threat intelligence information obtained by the cybersecurity provider;
evaluating performance of the first language model based on generating a plurality of database queries from a plurality of utterances with the first language model, wherein evaluating performance of the first language model comprises, for each utterance of a plurality of utterances,
running the first language model on a prompt comprising the utterance and obtaining a database query representing the utterance as a response to the prompt;
submitting the database query to the database; and
based on obtaining a result of submitting the database query, determining if the database query is valid based, at least in part, on a schema of the database; and
deploying the first language model for interfacing with a dialogue system based on determining that performance of the first language model is satisfactory.

2. The method of claim 1, wherein determining if the database query is valid comprises at least one of determining if the database query was able to execute and determining if the database query is consistent with the schema of the database.

3. The method of claim 2 further comprising,
based on a determination that the database query is valid, assigning a score to the database query indicating that the database query is valid; and
based on a determination that the database query is not valid, assigning a score to the database query indicating that the database query is invalid.

4. The method of claim 3, wherein evaluating performance of the first language model comprises evaluating scores assigned to the plurality of database queries, wherein determining that performance of the first language model is satisfactory comprises that the scores assigned to the plurality of database queries satisfy one or more criteria.

5. The method of claim 2 further comprising:
based on determining that the database query cannot execute, attempting to fix the database query to generate a fixed database query;
evaluating a response to submitting the fixed database query to the database;
based on determining from the response that the fixed database query is valid, assigning a score to the fixed database query indicating that the fixed database query is valid; and
based on determining from the response that the fixed database query is not valid, assigning a score to the fixed database query indicating that the fixed database query is invalid.

6. The method of claim 1 further comprising, based on deployment of the first language model,
based on obtaining a first utterance input to the dialogue system, running the first language model on a prompt comprising the first utterance to generate a database query representing the first utterance;
submitting the database query to the database to obtain a query result; and
constructing a response to the first utterance based on the query result.

7. The method of claim 6 further comprising evaluating the first utterance to determine whether to run the first language model with the first utterance, wherein evaluating the first utterance comprises at least one of determining if an intent of the first utterance relates to threat intelligence and determining if the first utterance comprises an injection attack.

8. The method of claim 7, wherein determining the intent of the first utterance comprises running a second language model on a prompt comprising the first utterance, wherein the second language model has been adapted to determine intents of utterances, and running the first language model with the first utterance based on determining that the intent relates to threat intelligence.

9. The method of claim 7, wherein determining if the first utterance comprises an injection attack comprises determining if the first utterance comprises a cross-site-scripting (XSS) attack or a prompt injection-based attack and responding to the first utterance without running the first language model based on determining that the first utterance comprises an XSS attack or a prompt injection-based attack.

10. The method of claim 1, wherein the first language model comprises a large language model (LLM), wherein adapting the first language model comprises prompt engineering or fine-tuning of the LLM.

11. The method of claim 1, wherein the database offered by the cybersecurity provider maintains at least one of Common Vulnerabilities and Exposures (CVE) data enriched by the cybersecurity provider and threat prevention information maintained by proprietary systems of the cybersecurity provider.

12. One or more non-transitory machine-readable media having program code stored thereon, the program code comprising instructions to:
adapt a language model to generate database queries from utterances, wherein the database queries are to be executed against a database offered by a cybersecurity provider, wherein the database maintains threat intelligence information obtained by the cybersecurity provider;
evaluate performance of the language model based on using the language model to generate a plurality of database queries from a plurality of utterances, wherein the instructions to evaluate performance of the language model comprise instructions to, for each utterance of a plurality of utterances,
run the language model on a prompt comprising the utterance and obtain a database query representing the utterance as a response to the prompt;
submit the database query to the database to obtain a result; and
based on the result of submitting the database query, determine whether the database query is valid based, at least in part, on a schema of the database; and
deploy the language model to interface with a dialogue system based on results of evaluating performance of the language model.

13. The non-transitory machine-readable media of claim 12, wherein the instructions to determine whether the database query is valid comprise at least one of instructions to determine whether the database query was able to execute and instructions to determine whether the database query is consistent with the schema of the database.

14. The non-transitory machine-readable media of claim 13 further comprising:
based on a determination that the database query is valid, assign a score to the database query indicating that the database query is valid; and
based on a determination that the database query is not valid, assign a score to the database query indicating that the database query is invalid,
wherein the instructions to evaluate performance of the language model comprise instructions to evaluate scores assigned to the plurality of database queries.

15. The non-transitory machine-readable media of claim 14, wherein the instructions to deploy the language model based on the results of evaluating performance of the language model comprise instructions to determine that the scores assigned to the plurality of database queries satisfy one or more criteria.

16. An apparatus comprising:
a processor; and
a machine-readable medium having instructions stored thereon that are executable by the processor to cause the apparatus to,
adapt a first language model to generate database queries from user queries, wherein the database queries are to be executed against a database offered by a cybersecurity provider, wherein the database maintains threat intelligence information obtained by the cybersecurity provider;
evaluate performance of the first language model based on generation of a plurality of database queries from a plurality of user queries with the first language model, wherein the instructions to evaluate performance of the first language model comprise instructions to,
run the first language model on a plurality of prompts formed from the plurality of user queries to obtain a corresponding plurality of database queries;
submit each of the plurality of database queries to the database; and
based on results of submission of the plurality of database queries to the database, determine if the first language model is generating valid database queries; and
deploy the first language model to interface with a dialogue system based on a determination that the first language model is generating valid database queries.

17. The apparatus of claim 16, wherein the instructions executable by the processor to cause the apparatus to determine if the first language model is generating valid database queries comprise at least one of instructions executable by the processor to cause the apparatus to determine if each of the plurality of database queries was able to execute and instructions executable by the processor to cause the apparatus to determine if each of the plurality of database queries is consistent with a schema of the database.

18. The apparatus of claim 17, further comprising instructions executable by the processor to cause the apparatus to, for each database query of the plurality of database queries,
based on a determination that the database query is valid, assign a score to the database query indicating that the database query is valid; and
based on a determination that the database query is not valid, assign a score to the database query indicating that the database query is invalid,
wherein the instructions executable by the processor to cause the apparatus to evaluate performance of the first language model comprise instructions executable by the processor to cause the apparatus to evaluate scores assigned to the plurality of database queries.

19. The apparatus of claim 18, wherein the instructions executable by the processor to cause the apparatus to determine if the first language model is generating valid database queries comprise instructions executable by the processor to cause the apparatus to determine if the scores assigned to the plurality of database queries satisfy one or more criteria.

20. The apparatus of claim 16, further comprising instructions executable by the processor to cause the apparatus to, based on deployment of the first language model,
run the first language model on a prompt comprising a first user query obtained as input to the dialogue system to generate a database query representing the first user query;
submit the database query to the database to obtain a query result; and
construct a response to the first user query based on the query result.
